(19) United States
(12) Patent Application Publication
(10) Pub. No.: US 2026/0006470 A1
(43) Pub. Date: Jan. 1, 2026

(54) COMMUNICATION METHOD, ELECTRONIC DEVICE AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/881,679

(22) PCT Filed: Jul. 6, 2022
(86) PCT No.: PCT/CN2022/104240

§ 371 Date: Jan. 6, 2025

(51) Int. Cl. H04W 24/08; G01S 7/00; G01S 13/86; H04L 67/147; H04W 84/12

(52) U.S. Cl. CPC H04W 24/08; G01S 7/006; G01S 13/86; H04L 67/147; H04W 84/12

(57) ABSTRACT

A communication method, performed by an SBP initiator, includes: determining a target radio frame, wherein the target radio frame comprises a first identification bit, and the first identification bit indicates whether an SBP responder feeds back sensing measurement results; and transmitting the target radio frame.

### CROSS-REFERENCE TO RELATED APPLICATION

This application is the U.S. national phase application of International Application No. PCT/CN2022/104240, filed on Jul. 6, 2022, the disclosure of which is incorporated herein by reference in its entirety for all purposes.

### TECHNICAL FIELD

Examples of the present disclosure relate to the field of mobile communication technologies. Particularly, the examples of the present disclosure relate to a communication method, an electronic device, and a storage medium.

### BACKGROUND

With the rapid development of mobile communication technologies, wireless fidelity (Wi-Fi) technologies have made great progress in terms of transmission rate and throughput. At present, the study of the Wi-Fi technologies includes, for example, 320 Mhz bandwidth transmission, multi-band aggregation and cooperation, etc., whose main application scenarios include video transmission, augmented reality (AR), virtual reality (VR), etc.

Specifically, the multi-band aggregation and cooperation refers to a communication between devices on 2.4 GHz, 5.8 GHz, 6 GHz and other frequency bands at the same time. It is required to define a new media access control (MAC) mechanism to handle a scenario of the communication between the devices on multiple frequency bands at the same time. In addition, the multi-band aggregation and cooperation may be able to support low latency transmission.

At present, a maximum bandwidth supported by the multi-band aggregation and cooperation technology is 320 MHz (i.e., 160 MHz+160 MHz). In addition, 240 MHz (i.e., 160 MHz+80 MHz) and other bandwidths supported by existing standards may also be supported.

For the Wi-Fi technologies currently being studied, wireless local area network (WLAN) sensing technologies may be supported, e.g. in application scenarios such as location discovery, proximity detection and presence detection in a dense environment (such as a home environment or a company environment).

In a WLAN sensing procedure, the roles of a station device (STA) and an access point device (AP) are usually interchangeable. For example, both may act as an initiator device (i.e., a sensing initiator or a sensing transmitter). When acting as the sensing initiator or the sensing transmitter, the AP may communicate with a plurality of STAs at the same time. However, the STA has no such capability and can only communicate one-to-one with a single responder (i.e., a sensing responder), wasting spectrum resources and increasing latency, which may not meet the latency requirements in communication scenarios with high latency requirements. In order to solve this problem, a scheme is proposed in which the AP serves as a proxy of the STA to perform a WLAN sensing measurement, namely sensing by proxy (SBP). However, in the SBP scenario, a mechanism for sensing receivers to feed back their measurement results is not specified in the art. Therefore, it is required to provide such a mechanism for the sensing receivers to feed back their measurement results in the SBP scenario.

### SUMMARY

Examples of the present disclosure provide a communication method, an electronic device, and a storage medium to provide a mechanism for sensing receivers to feed back measurement results in an SBP scenario.

In one aspect, the examples of the present disclosure provide a communication method, performed by a sensing by proxy (SBP) initiator, the method including: determining a target radio frame, wherein the target radio frame includes a first identification bit, and the first identification bit indicates whether an SBP responder feeds back sensing measurement results; and transmitting the target radio frame.

In another aspect, the examples of the present disclosure provide a communication method, performed by an SBP responder, the method including: receiving a target radio frame, wherein the target radio frame includes a first identification bit, and the first identification bit indicates whether the SBP responder feeds back sensing measurement results; and serving as a proxy of an SBP initiator to set up a sensing measurement with station devices (STAs) by transmitting a sensing measurement setup request frame to the STAs according to the first identification bit.

The examples of the present disclosure further provide an electronic device, including one or more memories, one or more processors, and a computer program stored in the one or more memories and executable on the one or more processors. The one or more processors, when executing the program, are configured to: determine a target radio frame, wherein the target radio frame includes a first identification bit, and the first identification bit indicates whether an SBP responder feeds back sensing measurement results; and transmit the target radio frame.

In the examples of the present disclosure, an SBP initiator determines and transmits a target radio frame. The target radio frame includes a first identification bit, and the first identification bit indicates whether an SBP responder feeds back sensing measurement results. The SBP responder is indicated by the target radio frame to determine whether sensing receivers feed back the sensing measurement results in an SBP procedure according to the first identification bit, thereby improving the SBP procedure.

For the additional aspects and advantages of the present disclosure, a part of them will be set forth in the following description, which will be apparent according to the following description or be learned through putting the present disclosure into practice.

### BRIEF DESCRIPTION OF THE DRAWINGS

The drawings to be used in the description of the examples of the present disclosure will be briefly introduced to explain the technical solutions provided by the examples of the present disclosure more clearly. It is evident that, the drawings in the following description illustrate only some examples of the present disclosure, and based on these drawings, those of ordinary skill in the art may obtain other drawings without creative work.

FIG. 1 is the first flowchart of the communication method provided in an example of the present disclosure.

FIG. 2 is the first schematic diagram of the first example according to an example of the present disclosure.

FIG. 3 is the second schematic diagram of the first example according to an example of the present disclosure.

FIG. 4 is the third schematic diagram of the first example according to an example of the present disclosure.

FIG. 5 is a schematic diagram of the second example according to an example of the present disclosure.

FIG. 6 is the second flowchart of the communication method provided in an example of the present disclosure.

FIG. 7 is the third flowchart of the communication method provided in an example of the present disclosure.

FIG. 8 is the first schematic structural diagram of the electronic device provided in an example of the present disclosure.

FIG. 9 is the second schematic structural diagram of the electronic device provided in an example of the present disclosure.

FIG. 10 is the third schematic structural diagram of the electronic device provided in an example of the present disclosure.

### DETAILED DESCRIPTION OF THE EMBODIMENTS

The term “and/or” in the examples of the present disclosure describes association relationships between associated objects, indicating that there can be three types of relationships. For example, A and/or B means that A exists alone, A and B exist at the same time, and B exists alone. The character “/” generally indicates that the associated objects before and after are in an “or” relationship.

The term “plurality” in the examples of the present disclosure refers to two or more than two, and other quantifiers are similar thereto.

Examples will be described in detail herein, whose instances are illustrated in the accompanying drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. Terms determined by “a,” “said” and “the” in their singular forms in the present disclosure and the appended claims are also intended to include their plural forms, unless clearly indicated otherwise in the context. It is also to be understood that the term “and/or” as used herein is and includes any and all possible combinations of one or more of the associated listed items.

It is to be understood that, although terms “first,” “second,” “third,” and the like may be used in the present disclosure to describe various information, such information is not be limited to these terms. These terms are only used to distinguish the information of the same type with each other. For example, without departing from the scope of the present disclosure, first information may be referred as second information; and similarly, second information may also be referred as first information. Depending on the context, the word “if” as used herein may be interpreted as “when,” “upon,” or “in response to determining.”

The following, in conjunction with the drawings of the examples of the present disclosure, will clearly and completely describe the technical solutions provided in the examples of the present disclosure. It is obvious that the described examples are a part, but not all, of the examples of the present disclosure. Based on the examples provided in the present disclosure, all of other examples, which can be obtained by those of ordinary skill in the art without creative work, shall fall within the protection scope of the present disclosure.

The examples of the present disclosure provide a communication method, an electronic device, and a storage medium to provide a mechanism for sensing receivers to feed back measurement results in an SBP scenario.

The methods and the apparatuses are based on the same disclosed concept. For the methods and the apparatuses, their implementations can refer to each other since their principles of solving problems are similar, and their repeated parts are not to be repeated.

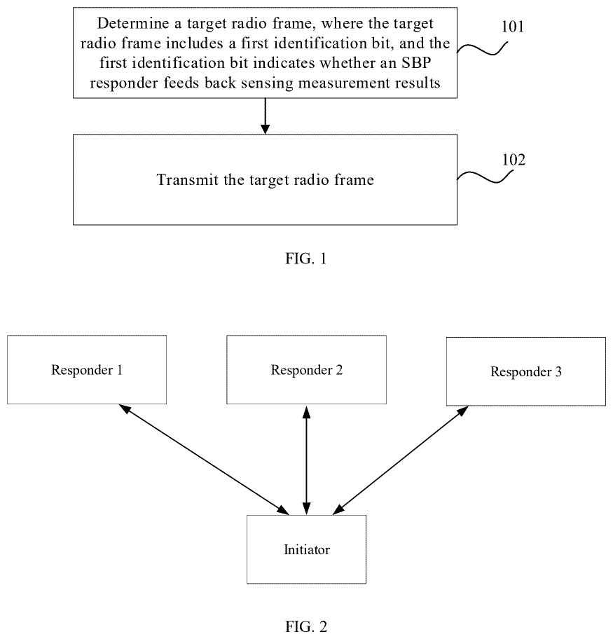

As illustrated in FIG. 1, an example of the present disclosure provides a communication method. Alternatively, or additionally, the method may be applied to a sensing by proxy (SBP) initiator. The SBP initiator may be a station device (STA). The method may include the following steps.

At step 101, a target radio frame is determined. The target radio frame includes a first identification bit, and the first identification bit indicates whether an SBP responder feeds back sensing measurement results.

As the first example, referring to FIG. 2 to FIG. 4, wireless local area network (WLAN) sensing architectures and WLAN sensing procedures to which the communication methods provided in the examples of the present disclosure are applied are first introduced.

FIG. 2 illustrates a schematic diagram of an architecture of a WLAN sensing (procedure). A sensing initiator (or an initiator) initiates the WLAN sensing (e.g., initiates a WLAN sensing session). There may be a plurality of sensing responders (or sensing receivers) or responders responding thereto, as illustrated by Responder 1, Responder 2, and Responder 3 in FIG. 2. When the sensing initiator initiates the WLAN sensing, the plurality of associated or unassociated sensing responders of the WLAN sensing may perform the response.

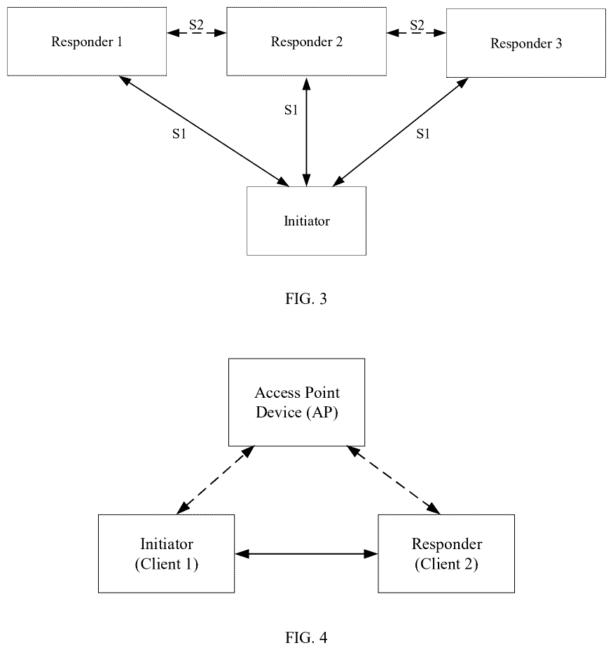

Referring to FIG. 3, the sensing initiator communicates with the sensing responders via communication connections, as illustrated by communication connection S1, and the sensing responders communicate with each other via communication connections S2.

Each sensing initiator may be a client, and each sensing responder (i.e., sensing Responder 1 to sensing Responder 3 in the example) may be an STA or an access point device (AP). In addition, the STA and the AP may play multiple roles in the WLAN sensing procedure. For example, the STA may also act as the sensing initiator in the WLAN sensing procedure. The sensing initiator may be a sensing transmitter, a sensing receiver, or both, or neither. The sensing responder may be the sensing transmitter, the sensing receiver, or both in the WLAN sensing procedure.

As another architecture, as illustrated in FIG. 4, the sensing initiator and the sensing responder may be both clients, and the two may communicate by connecting to the same AP. In FIG. 4, Client 1 is the sensing initiator, and Client 2 is the sensing responder.

Generally, when acting as the sensing initiator or the sensing transmitter, the STA has no capability of communicating with a plurality of receivers at the same time, so a proxy device (e.g., an AP) is required to serve as a proxy of the STA to perform a sensing measurement. In an SBP scenario, the SBP initiator (e.g., the STA) determines the target radio frame. The first identification bit is carried in the target radio frame. The first identification bit indicates whether the SBP responder (e.g., the AP) feeds back the sensing measurement results. For example, the target radio frame may be an SBP request frame. The SBP initiator transmits the SBP request frame to the SBP responder. The first identification bit is carried in the SBP request frame. For example, the first identification bit is set to “1”, indicating that the SBP responder is expected to feed back the sensing measurement results, and the first identification bit is set to “0”, indicating that the SBP responder is not expected to feed back the sensing measurement results.

At step 102, the target radio frame is transmitted.

The SBP initiator transmits the target radio frame, so as to instruct the SBP responder to determine whether to feed back the sensing measurement results of the SBP procedure according to the first identification bit, thereby improving the SBP procedure. If the first identification bit indicates that the sensing measurement results are to be fed back, the SBP responder controls the sensing receivers to feed back their sensing measurement results in the SBP procedure, and feeds back the sensing measurement results to the SBP initiator.

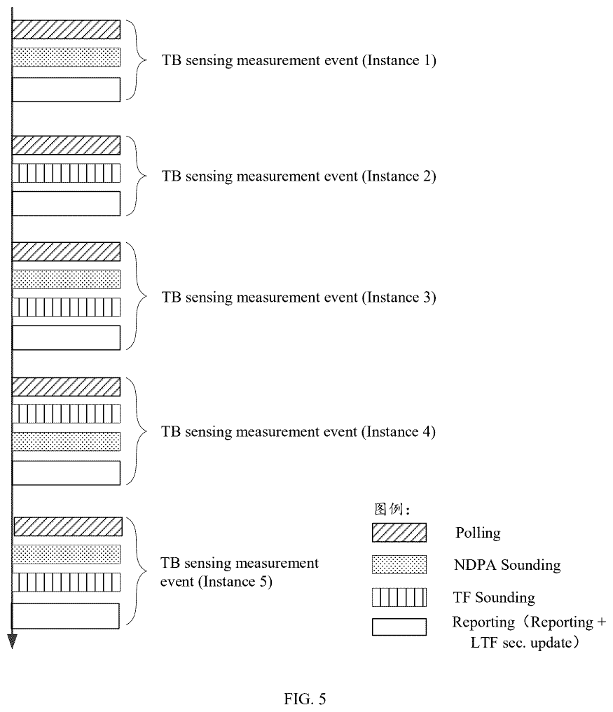

In addition, the WLAN sensing procedure generally includes a triggered based sounding (TB) mode and a non-TB based sensing mode. Specifically, the TB sensing measurement mode means that the AP acts as the initiator or the transmitter, and the non-TB sensing measurement mode means that the STA acts as the initiator or the transmitter. In an example of the present disclosure, an AP initiates a TB sensing measurement in an SBP procedure. As the second example, a TB sensing measurement procedure is illustrated in FIG. 5. FIG. 5 illustrates multiple sensing measurement events of the sensing measurement in one TB sensing measurement procedure. Particularly, the sensing measurement procedure in each of Instance 1 to Instance 5 includes polling, sounding, and reporting (Reporting+light-to-frequency (LTF) sec.update) processes. In each instance, the sounding may include a null data packet announcement (NDPA) sounding only, a trigger frame (TF) sounding only, or the two at the same time.

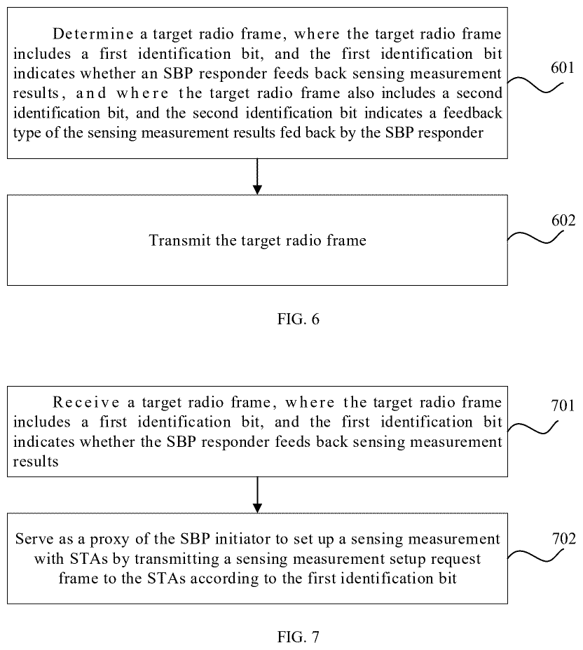

Referring to FIG. 6, an example of the present disclosure provides a communication method. Alternatively, or additionally, the method may be applied to an SBP initiator. The method may include the following steps.

At step 601, a target radio frame is determined. The target radio frame includes a first identification bit, and the first identification bit indicates whether an SBP responder feeds back sensing measurement results.

The target radio frame also includes a second identification bit, and the second identification bit indicates a feedback type of the sensing measurement results fed back by the SBP responder. That is, the second identification bit identifies information on the feedback type of the sensing measurement results.

The feedback type indicates a parameter included in the sensing measurement results, for example, including channel state indication (CSI) information.

At step 602, the target radio frame is transmitted.

The SBP initiator transmits the target radio frame, so as to instruct the SBP responder to determine whether to feed back the sensing measurement results of an SBP procedure according to the first identification bit, thereby improving the SBP procedure. If the first identification indicates the feedback of the sensing measurement results, the SBP responder controls sensing receivers to feed back their measurement results during the SBP procedure.

In an alternative or additional example, in a case that the first identification bit has a first parameter value, the second identification bit has a second parameter value. The second parameter value indicates that the feedback type is to feed back CSI information. For example, the first identification bit is “1”, indicating that the sensing measurement results are expected to be fed back. In this case, the second identification bit is set to a corresponding value, for example, set to 1, indicating that the CSI is fed back.

An example of the present disclosure provides a communication method. Alternatively, or additionally, the method may be applied to an SBP initiator. The method may include the following steps.

Determining a target radio frame, where the target radio frame includes a first identification bit, and the first identification bit indicates whether an SBP responder feeds back sensing measurement results.

Transmitting the target radio frame.

Receiving an SBP response frame that includes a sensing measurement setup identifier (MSID).

The SBP initiator transmits the SBP responder the SBP request frame, which indicates whether the SBP responder feeds back the sensing measurement results. After transmitting the target radio frame, the SBP initiator receives the SBP response frame transmitted by the SBP responder. If the first identification indicates that the SBP responder feeds back the sensing measurement results, the SBP initiator obtains the sensing measurement results from the SBP response frame, and determines the measurement setup procedure corresponding to the sensing measurement results according to the sensing MSID.

In the examples of the present disclosure, the SBP initiator determines and transmits the target radio frame. The target radio frame includes the first identification bit, which indicates whether the SBP responder feeds back the sensing measurement results. The target radio frame indicates the SBP responder to determine according to the first identification bit whether sensing receivers of a SBP procedure feed back their sensing measurement results, thereby improving the SBP procedure. The example of the present disclosure provides a mechanism for the sensing receivers to feed back the measurement results in an SBP scenario.

Referring to FIG. 7, an example of the present disclosure provides a communication method. Alternatively, or additionally, the method may be applied to an SBP responder. The SBP responder may be an AP. The method may include the following steps.

At step 701, a target radio frame is received. The target radio frame includes a first identification bit, and the first identification bit indicates whether the SBP responder feeds back sensing measurement results.

The WLAN sensing architectures and the WLAN sensing procedures to which the communication method provided in the example of the present disclosure refer to the first example, and the TB sensing measurement process initiated by the SBP responder in an SBP procedure refers to the second example, which will not be repeated here.

Generally, when acting as a sensing initiator or a sensing transmitter, an STA has no capability of communicating with a plurality of receivers at the same time, so a proxy device (e.g., an AP) is required to serve as a proxy of the STA and perform a sensing measurement. In an SBP scenario, the SBP responder receives the target radio frame, obtains the first identification bit carried in the target radio frame, and determines whether to feed back the sensing measurement results according to the first identification bit. For example, the target radio frame may be an SBP request frame. The SBP initiator transmits the SBP responder the SBP request frame that carries the first identification bit. The first identification bit is set to “1”, indicating that the SBP responder is expected to feed back the sensing measurement results, so that the SBP responder controls the sensing receivers to feed back their sensing measurement results during the SBP procedure, and feeds back the sensing measurement results to the SBP initiator. The first identification bit is set to “0”, indicating that the SBP responder is not expected to feed back the sensing measurement results.

At step 702, it serves as a proxy of the SBP initiator to set up a sensing measurement with STAs by transmitting a sensing measurement setup request frame to the STAs according to the first identification bit.

The SBP responder serves as the proxy of the SBP initiator to set up the sensing measurement with the STAs and transmits the sensing measurement setup request frame to the STAs according to the first identification bit. It is determined whether the STAs (i.e., the sensing receivers) feed back their sensing measurement results, thereby improving the SBP procedure. For example, the first identification bit indicates that the sensing measurement results are to be fed back, and thus the SBP responder instructs the sensing receivers (i.e., the STAs) through the sensing measurement setup request frame to feed back their sensing measurement results. Subsequently, the SBP responder feeds back the sensing measurement results to the SBP initiator.

An example of the present disclosure further provides a communication method. Alternatively, or additionally, the method may be applied to an SBP responder. The SBP responder may be an AP. The method may include the following steps.

Receiving a target radio frame, where the target radio frame includes a first identification bit, and the first identification bit indicates whether the SBP responder feeds back sensing measurement results.

Serving as a proxy of an SBP initiator to set up a sensing measurement with STAs, and determining, according to the first identification bit, a value of a sensing measurement result indication bit of a sensing measurement parameters element, where the sensing measurement result indication bit indicates whether sensing receivers feed back their sensing measurement results.

Transmitting the sensing measurement setup request frame to the STAs, with the sensing measurement parameters element carried in the sensing measurement setup request frame.

An example of the present disclosure further provides a communication method. Alternatively, or additionally, the method may be applied to an SBP responder. The SBP responder may be an AP. The method may include the following steps.

Receiving a target radio frame, where the target radio frame includes a first identification bit, and the first identification bit indicates whether the SBP responder feeds back sensing measurement results, and where the target radio frame also includes a second identification bit, and the second identification bit indicates a feedback type of the sensing measurement results fed back by the SBP responder.

Serving as a proxy of an SBP initiator to set up a sensing measurement with STAs by transmitting a sensing measurement setup request frame to the STAs according to the first identification bit, where the second identification bit identifies information on the feedback type of the sensing measurement results, and the feedback type indicates a parameter included in the sensing measurement results.

Determining, according to the second identification bit, a value of a sensing measurement result type indication bit of a sensing measurement parameters element.

Transmitting the sensing measurement setup request frame to the STAs, with the sensing measurement parameters element carried in the sensing measurement setup request frame.

As a third example, the format of the sensing measurement parameters element for the SBP measurement is shown in the following Table 1.

TABLE 1

| | Element | | | Sensing | To be |
|---|---|---|---|---|---|
| Information | Identification | | Element ID | Measurement | determined |
| Content | (ID) | Length | Extension | Parameters | (TBD) |
| Octets | 1 | 1 | 1 | TBD | TBD |

The sensing measurement parameters element includes an element identification field, a length field, an element identification extension field, a sensing measurement parameters field, etc. Furthermore, a format of the sensing measurement parameters field is shown in the following Table 2.

TABLE 2

| | | | Sensing | | |
|---|---|---|---|---|---|
| | | | Measurement | | |
| | | | Result | | |
| | | | (Sensing | | |
| Information | Sensing | Sensing | Measurement | Measurement | |
| Content | Transmitter | Receiver | Report) | Report Type | TBD |
| Octets | 1 | 1 | 1 | TBD | TBD |

As shown in Table 2, the sensing measurement parameters field includes a sensing transmitter indication bit, a sensing receiver indication bit, a sensing measurement result indication bit (which is the same as the first identification bit), and a sensing measurement result feedback type indication bit (which is the same as the second identification bit). The sensing measurement result indication bit indicates whether the sensing receivers feed back their sensing measurement result. The sensing measurement result feedback type indication bit indicates the feedback type of the sensing measurement results fed back by the sensing receiver.

In an alternative or additional example, in a case where the first identification bit has a first parameter value, the second identification bit has a second parameter value. The second parameter value indicates that the feedback type is to feed back CSI information. For example, the first identification bit is “1”, indicating that the sensing measurement results are expected to be fed back. In this case, the second identification bit is set to a corresponding value, for example, set to 1, indicating that the CSI is fed back.

An example of the present disclosure further provides a communication method. Alternatively, or additionally, the method may be applied to an SBP responder. The SBP responder may be an AP. The method may include the following steps.

Receiving a target radio frame, where the target radio frame includes a first identification bit, and the first identification bit indicates whether the SBP responder feeds back sensing measurement results, and where the target radio frame includes an SBP request frame.

Serving as a proxy of an SBP initiator to set up a sensing measurement with STAs by transmitting a sensing measurement setup request frame to the STAs according to the first identification bit.

Transmitting an SBP response frame to the SBP initiator, where the SBP response frame includes a sensing MSID.

The SBP responder receives the SBP request frame, obtains the first identification bit, transmits the sensing measurement setup request frame to the STAs according to the first identification bit to instruct the STAs whether to feed back their sensing measurement results, and initiates the SBP response frame to the SBP initiator. If the first identification bit indicates that the SBP responder feeds back the sensing measurement results, the sensing measurement results are transmitted to the SBP initiator through the SBP response frame, which carries the sensing MSID to indicate the measurement setup procedure corresponding to the sensing measurement results.

In the example of the present disclosure, the SBP responder receives the target radio frame. The target radio frame includes the first identification bit. The first identification bit indicates whether the SBP responder feeds back the sensing measurement results. The SBP responder serves as the proxy of the SBP initiator to set up the sensing measurement with the STAs (i.e., the sensing receivers) by transmitting the sensing measurement setup request frame to the STAs according to the first identification bit, so as to instruct the STAs whether to feed back the sensing measurement results, thereby improving the SBP procedure. The example of the present disclosure provides a mechanism for the sensing receivers to feed back the measurement results in an SBP scenario.

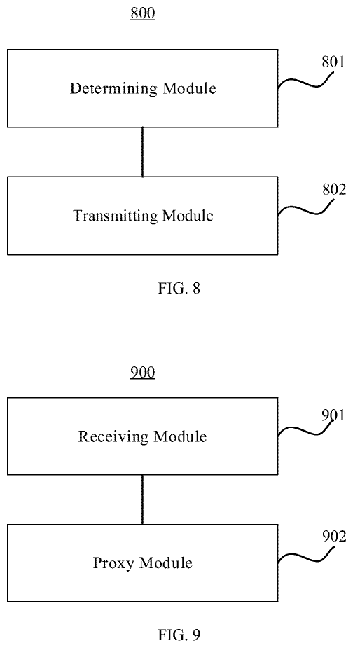

Referring to FIG. 8, based on the same principle as the methods provided in the examples of the present disclosure, an example of the present disclosure further provides an electronic device 800. The electronic device 800 is an SBP initiator. The electronic device 800 includes: a determining module 801 that is configured to determine a target radio frame, where the target radio frame includes a first identification bit, and the first identification bit indicates whether an SBP responder feeds back sensing measurement results; and a transmitting module 802 that is configured to transmit the target radio frame.

In an alternative or additional example, the target radio frame further includes a second identification bit.

The second identification bit indicates a feedback type of the sensing measurement results fed back by the SBP responder.

In an alternative or additional example, the second identification bit has a second parameter value in a case that the first identification bit has a first parameter value.

The second parameter value indicates that the feedback type is to feed back CSI information.

In an alternative or additional example, the target radio frame includes an SBP request frame.

After transmitting the target radio frame, the electronic device is further configured to: receive an SBP response frame that includes a sensing MSID.

In the example of the present disclosure, the determining module 801 determines the target radio frame, and the transmitting module 802 transmits the target radio frame. The target radio frame includes the first identification bit, and the first identification bit indicates whether the SBP responder feeds back the sensing measurement results. The SBP responder is indicated by the target radio frame to determine whether the sensing receivers of the SBP procedure feed back their sensing measurement results according to the first identification bit, thereby improving the SBP procedure.

An example of the present disclosure further provides a communication apparatus, which is applied to an SBP initiator. The apparatus includes: a radio frame determining module that is configured to determine a target radio frame, where the target radio frame includes a first identification bit, and the first identification bit indicates whether an SBP responder feeds back sensing measurement results; and a radio frame transmitting module that is configured to transmit the target radio frame.

The apparatus also includes other modules of the electronic device in the foregoing example, which will not be repeated here.

Referring to FIG. 9, based on the same principle as the methods provided in the examples of the present disclosure, an example of the present disclosure further provides an electronic device 900. The electronic device 900 is an SBP responder. The electronic device 900 includes: a receiving module 901 that is configured to receive a target radio frame, where the target radio frame includes a first identification bit, and the first identification bit indicates whether the SBP responder feeds back sensing measurement results; and a proxy module 902 that is configured to serve as a proxy of an SBP initiator to set up a sensing measurement with STAs by transmitting a sensing measurement setup request frame to the STAs according to the first identification bit.

In an alternative or additional example, the proxy module 902 includes: a determining submodule that is configured to determine, according to the first identification bit, a value of a sensing measurement result indication bit of a sensing measurement parameters element; and a transmitting submodule that is configured to transmit the sensing measurement setup request frame to the STAs, with the sensing measurement parameters element carried in the sensing measurement setup request frame.

In an alternative or additional example, the target radio frame further includes a second identification bit. The second identification bit indicates a feedback type of the sensing measurement results fed back by the SBP responder.

Before carrying the sensing measurement parameters element in the sensing measurement setup request frame, the determining submodule is further configured to: determine, according to the second identification bit, a value of a sensing measurement result type indication bit of the sensing measurement parameters element.

In an alternative or additional example, the second identification bit has a second parameter value in a case that the first identification bit has a first parameter value.

The second parameter value indicates that the feedback type is to feed back CSI information.

In an alternative or additional example, the target radio frame includes an SBP request frame.

The electronic device further includes: a response transmitting module that is configured to after the proxy module 902 serves as the proxy of the SBP initiator to set up the sensing measurement with the STAs by transmitting the sensing measurement setup request frame to the STAs according to the first identification bit, initiate an SBP response frame to the SBP initiator, where the SBP response frame includes a sensing MSID.

In the example of the present disclosure, the receiving module 901 receives the target radio frame. The target radio frame includes the first identification bit. The first identification bit indicates whether the SBP responder feeds back the sensing measurement results. The proxy module 902 serves as the proxy of the SBP initiator to set up the sensing measurement with the STAs (i.e., the sensing receivers) by transmitting the sensing measurement setup request frame to the STAs according to the first identification bit, so as to instruct the STAs whether to feed back their sensing measurement results, thereby improving the SBP procedure.

An example of the present disclosure further provides a communication apparatus, which is applied to an SBP responder. The apparatus includes: a radio frame receiving module that is configured to receive a target radio frame, where the target radio frame includes a first identification bit, and the first identification bit indicates whether the SBP responder feeds back sensing measurement results; and a radio frame proxy module that is configured to serve as a proxy of an SBP initiator to set up a sensing measurement with STAs by transmitting a sensing measurement setup request frame to the STAs according to the first identification bit.

The apparatus also includes other modules of the electronic device in the foregoing example, which will not be repeated here.

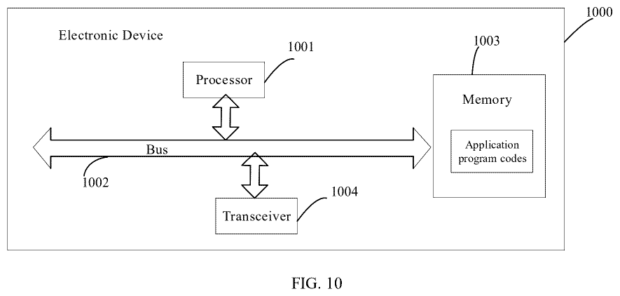

In an alternative or additional example, the examples of the present disclosure further provide an electronic device. As illustrated in FIG. 10, the electronic device 1000 illustrated in FIG. 10 may be a server, including: a processor 1001 and a memory 1003. The processor 1001 and the memory 1003 are connected, for example, via a bus 1002. Alternatively, or additionally, the electronic device 1000 may further include a transceiver 1004. It is to be noted that in actual applications, the number of transceivers 1004 is not limited to one, and the structure of the electronic device 1000 does not constitute a limitation on the example of the present disclosure.

The processor 1001 may be a central processing unit (CPU), a general-purpose processor, a digital signal processor (DSP), an application specific integrated circuit (ASIC), a field programmable gate array (FPGA) or another programmable logic device, transistor logic device, hardware component or any combination thereof. The processor may implement or execute various illustrative logical blocks, modules, and circuits described in conjunction with the disclosed contents of the present disclosure. The processor 1001 may also be a combination for implementing computing functions, such as a combination of one or more microprocessors, and a combination of a DSP and a microprocessor.

The bus 1002 may include a pathway for transmitting information between the above components. The bus 1002 may be a peripheral component interconnect (PCI) bus or an extended industry standard architecture (EISA) bus, etc. The bus 1002 may be divided into an address bus, a data bus, a control bus, and so on. For ease of representation, only a thick line is illustrated in FIG. 10, but it does not mean that there is only one bus or one type of bus.

The memory 1003 may be a read-only memory (ROM) or other types of static storage devices that can store static information and instructions, a random access memory (RAM) or other types of dynamic storage devices that can store information and instructions, or an electrically erasable programmable read-only memory (EEPROM), a compact disc read-only memory (CD-ROM) or other optical disc storage, optical disk storage (including compressed optical disk, laser disk, optical disk, digital versatile disk, Blu-ray disk, etc.), a magnetic disk storage medium or other magnetic storage devices, or any other medium that can be configured to carry or store the desired program codes in the form of instructions or data structures and can be accessed by a computer, but is not limited to these.

The memory 1003 is configured to store application program codes for executing the examples of the present disclosure, and the execution is controlled by the processor 1001. The processor 1001 is configured to execute the application program codes stored in the memory 1003 to implement the contents illustrated in the foregoing method examples.

The electronic devices include, but are not limited to, mobile terminals including mobile phones, laptops, digital broadcast receivers, personal digital assistants (PDA), pads, portable multimedia players (PMPs), vehicle-mounted terminals (such as vehicle-mounted navigation terminals), etc., and fixed terminals including digital TVs, desktop computers, etc. The electronic device illustrated in FIG. 10 is merely an example and does not limit the functions and the usage scope of the examples of the present disclosure.

The server provided in the present disclosure be an independent physical server, a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks (CDNs), big data and artificial intelligence platforms. The terminal may be a smart phone, a pad, a laptop computer, a desktop computer, a smart speaker, a smart watch, etc., but is not limited thereto. The terminal and the server may be connected directly or indirectly via wired or wireless communication, which is not limited in the present disclosure.

An example of the present disclosure provides a computer-readable storage medium, on which a computer program is stored. The computer program, when running on a computer, enables the computer to perform the corresponding contents of the foregoing method examples.

Although the steps in the flowcharts of the accompanying drawings are displayed sequentially as indicated by the arrows, it is to be understood that these steps are not necessarily performed sequentially in the order indicated by the arrows. Unless otherwise specified herein, there is no strict order limitation for performing these steps and these steps may be performed in other orders. In addition, at least part of the steps in the flowcharts of the accompanying drawings may include multiple sub-steps or multiple phases. These sub-steps or phases are not necessarily performed at the same time, but may be performed at different moments. The order of these sub-steps or phases is not necessarily sequential, but may rotate or alternate with at least part of another step or sub-steps or phases of another step.

It is to be noted that the computer-readable storage medium in the present disclosure may be a computer-readable signal medium, a computer-readable storage medium or any combination of the two. The computer readable storage medium may be, for example but not limited to, an electronic, magnetic, optical, electromagnetic, infrared, or semiconductor system, apparatus, or component, or any combination thereof. More specific examples of the computer-readable storage medium may include, but are not limited to, an electrical connection having one or more conductors, a portable computer disk, a hard disk, an RAM, an ROM, an erasable programmable read-only memory (EPROM or a flash memory), an optical fiber, a portable CD-ROM, an optical storage device, a magnetic storage device, or any suitable combination thereof. In the present disclosure, the computer-readable storage medium may be any tangible medium that contains or stores a program that may be use by or in connection with an instruction execution system, apparatus, or device. In the present disclosure, a computer-readable signal medium may include data signals propagated in a baseband or as a part of a carrier wave, in which computer-readable program codes are carried. Such the propagated data signals may take a variety of forms, including but not limited to electromagnetic signals, optical signals, or any suitable combination thereof. The computer-readable signal medium may also be any computer-readable medium other than the computer-readable storage medium, which may send, propagate, or transport the program that is use by or in connection with the instruction execution system, apparatus, or device. The program codes contained on the computer-readable medium may be transmitted via any appropriate medium, including but not limited to: a wire, an optical cable, radio frequency (RF), etc., or any suitable combination thereof.

The computer-readable medium may be included in the electronic device, or may exist independently without being equipped into the electronic device.

The computer-readable medium carries one or more programs. The one or more programs, when executed by the electronic device, enable the electronic device to perform the methods illustrated in the foregoing examples.

According to one aspect of the present disclosure, a computer program product or a computer program is provided. The computer program product or the computer program includes computer instructions stored in a computer-readable storage medium. One or more processors of a computer device read the computer instructions from the computer-readable storage medium and execute the computer instructions, so that the computer device performs the methods provided in the various candidate implementations.

Computer program codes for performing operations of the present disclosure may be written in one or more programming languages, or a combination thereof, including object-oriented programming languages such as Java, Smalltalk, C++, and conventional procedural programming languages such as “C” or similar programming languages. The program codes may be executed entirely on a user computer, partly on the user computer, as a stand-alone software package, partly on the user computer and partly on a remote computer, or entirely on the remote computer or server. In a case involving a remote computer, the remote computer may be connected to the user computer through any type of network, including a local area network (LAN) or a wide area network (WAN), or may be connected to an external computer, for example, through the Internet by an Internet service provider.

The flowcharts and block diagrams in the accompanying drawings illustrate possible implementation architectures, functions, and operations of the systems, the methods, and the computer program products according to various examples of the present disclosure. In this regard, each block in the flowchart or block diagram may represent a module, a program segment or a portion of codes, which contains one or more executable instructions for implementing the specified logical functions. It is also to be noted that, in some alternative implementations, the functions pointed by the blocks may occur out of the order pointed by the accompanying drawings. For example, two blocks shown in succession may actually be executed substantially in parallel, or may sometimes be executed in a reverse order, depending on the involved functions. It is also to be noted that each block in the block diagram and/or flowchart, and a combination of blocks in the block diagram and/or flowchart, may be implemented by a dedicated hardware-based system that performs a specified function or operation, or may be implemented by a combination of dedicated hardware and computer instructions.

The modules involved in the described examples of the present disclosure may be implemented by software or by hardware. The name of a module does not, in some cases, constitute a limitation on the module itself. For example, module A may also be described as “module A for performing operation B”.

The above description is only an illustration of the preferred examples of the present disclosure and the used technical principles. Those skilled in the art understand that the scope of disclosure involved in the present disclosure is not limited to the technical solutions formed by specific combinations of the above technical features, but also covers other technical solutions formed by any combination of the above technical features or their equivalent features without departing from the disclosure concepts, for example, the technical solutions formed by replacing the above features with, but not limited to, the technical features having similar functions disclosed in the present disclosure.

1. A communication method, performed by a sensing by proxy (SBP) initiator, the method comprising:
determining a target radio frame, wherein the target radio frame comprises a first identification bit, and the first identification bit indicates whether an SBP responder feeds back sensing measurement results; and
transmitting the target radio frame.

2. The communication method according to claim 1, wherein the target radio frame further comprises a second identification bit, and the second identification bit indicates a feedback type of the sensing measurement results fed back by the SBP responder.

3. The communication method according to claim 2, wherein the second identification bit has a second parameter value in a case that the first identification bit has a first parameter value, and the second parameter value indicates that the feedback type is feedback channel state indication (CSI) information.

4. The communication method according to claim 1,
wherein the target radio frame comprises an SBP request frame; and
wherein the method further comprises:
receiving an SBP response frame, wherein the SBP response frame comprises a sensing measurement setup identifier (MSID).

5. A communication method, performed by a sensing by proxy (SBP) responder, the method comprising:
receiving a target radio frame, wherein the target radio frame comprises a first identification bit, and the first identification bit indicates whether the SBP responder feeds back sensing measurement results; and
serving as a proxy of an SBP initiator to set up a sensing measurement with station devices (STAs) by transmitting a sensing measurement setup request frame to the STAs according to the first identification bit.

6. The communication method according to claim 5, wherein transmitting the sensing measurement setup request frame to the STAs according to the first identification bit comprises:
determining, according to the first identification bit, a value of sensing measurement result indication bit of a sensing measurement parameters element; and
transmitting the sensing measurement setup request frame to the STAs, with carrying the sensing measurement parameters element in the sensing measurement setup request frame.

7. The communication method according to claim 6,
wherein the target radio frame further comprises a second identification bit, and the second identification bit indicates a feedback type of the sensing measurement results fed back by the SBP responder; and
wherein the method further comprises:
determining, according to the second identification bit, a value of a sensing measurement result type indication bit of the sensing measurement parameters element.

8. The communication method according to claim 7, wherein the second identification bit has a second parameter value in a case that the first identification bit has a first parameter value, and the second parameter value indicates that the feedback type is feedback channel state indication (CSI) information.

9. The communication method according to claim 5,
wherein the target radio frame comprises an SBP request frame; and
wherein the method further comprises:
initiating an SBP response frame to the SBP initiator, wherein the SBP response frame comprises a sensing measurement setup identifier (MSID).

10-11. (canceled)

12. An electronic device, comprising:
one or more memories,
one or more processors, and
a computer program stored in the one or more memories and executable on the one or more processors,
wherein the computer program, when collectively executed by the one or more processors, causes the electronic device to:
determine a target radio frame, wherein the target radio frame comprises a first identification bit, and the first identification bit indicates whether a sensing by proxy (SBP) responder feeds back sensing measurement results; and
transmit the target radio frame.

13. A non-transitory computer-readable storage medium, having a computer program stored thereon, wherein the computer program, when collectively executed by one or more processors of the SBP initiator, causes the SBP initiator to perform the method according to claim 1.

14. A non-transitory computer-readable storage medium, having a computer program stored thereon, wherein the computer program, when collectively executed by one or more processors of the SBP responder, causes the SBP responder to perform the method according to claim 5.

15. The electronic device according to claim 12, wherein the target radio frame further comprises a second identification bit, and the second identification bit indicates a feedback type of the sensing measurement results fed back by the SBP responder.

16. The electronic device according to claim 15, wherein the second identification bit has a second parameter value in a case that the first identification bit has a first parameter value, and the second parameter value indicates that the feedback type is feedback channel state indication (CSI) information.

17. The electronic device according to claim 12,
wherein the target radio frame comprises an SBP request frame; and
wherein the one or more processors are further configured to:
receive an SBP response frame, wherein the SBP response frame comprises a sensing measurement setup identifier (MSID).

18. An electronic device, comprising:
one or more memories,
one or more processors, and
a computer program stored in the one or more memories and executable on the one or more processors,
wherein the computer program, when collectively executed by the one or more processors, causes the electronic device to act as the SBP responder and perform the communication method according to claim 5.

19. The electronic device according to claim 18, wherein for transmitting the sensing measurement setup request frame to the STAs according to the first identification bit, wherein the computer program when collectively executed by the one or more processors further cause the electronic device to:
determine, according to the first identification bit, a value of sensing measurement result indication bit of a sensing measurement parameters element; and
transmit the sensing measurement setup request frame to the STAs, with carrying the sensing measurement parameters element in the sensing measurement setup request frame.

20. The electronic device according to claim 19,
wherein the target radio frame further comprises a second identification bit, and the second identification bit indicates a feedback type of the sensing measurement results fed back by the SBP responder; and
wherein the computer program when collectively executed by the one or more processors further cause the electronic device to:
determine, according to the second identification bit, a value of a sensing measurement result type indication bit of the sensing measurement parameters element.

21. The electronic device according to claim 20, wherein the second identification bit has a second parameter value in a case that the first identification bit has a first parameter value, and the second parameter value indicates that the feedback type is feedback channel state indication (CSI) information.

22. The electronic device according to claim 18,
wherein the target radio frame comprises an SBP request frame; and
wherein the computer program when collectively executed by the one or more processors further cause the electronic device to:
initiate an SBP response frame to the SBP initiator, wherein the SBP response frame comprises a sensing measurement setup identifier (MSID).
